(19) United States
(12) Patent Application Publication
(10) Pub. No.: US 2013/0092514 A1
(43) Pub. Date: Apr. 18, 2013

(54) CONNECTOR ASSEMBLY

(71) Applicants: GUO-YI CHEN, Shenzhen City (CN); LEI LIU, Shenzhen City (CN)

(72) Inventors: GUO-YI CHEN, Shenzhen City (CN); LEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/427,571

(22) Filed: Mar. 22, 2012

(30) Foreign Application Priority Data
Oct. 12, 2011 (CN) 201110308114.9

(51) Int. Cl. H01R 24/00

(52) U.S. Cl. 200/51.05

(57) ABSTRACT

A connector assembly is connected between a motherboard and a backplane. The connector assembly includes a mini serial attached small computer system interface (Mini-SAS) connector, a serial advanced technology attachment (SATA) connector, and a switch unit. The switch unit includes first to fourth single-pole double-throw (SPDT) switches. When poles of the first to fourth SPDT switches are correspondingly connected to first throws of the first to fourth SPDT switches, the Min-SAS connector is connected to the motherboard, and the SATA connector is connected to the backplane. When the poles of the first to fourth SPDT switches are correspondingly connected to second throws of the first to fourth SPDT switches, the Min-SAS connector is connected to the backplane, and the SATA connector is connected to the motherboard.

### BACKGROUND

1. Technical Field

The present disclosure relates to a connector assembly.

2. Description of Related Art

In a server, a connector assembly is used to connect a motherboard and a backplane in the server. The connector assembly includes a mini serial attached small computer system interface (Mini-SAS) connector and a serial advanced technology attachment (SATA) connector. However, when the Mini-SAS connector is connected to the motherboard and the SATA connector is connected to the backplane, a first type of connector assembly is needed. When the Mini-SAS connector is connected to the backplane and the SATA connector is connected to the motherboard, a second type of connector assembly is needed. As a result, it is inconvenient.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an exemplary embodiment of a connector assembly.

FIG. 2 is a circuit diagram of the connector assembly of FIG. 1.

FIGS. 3 and 4 are schematic block diagrams of the connector assembly of FIG. 1 connected between a motherboard and a backboard.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

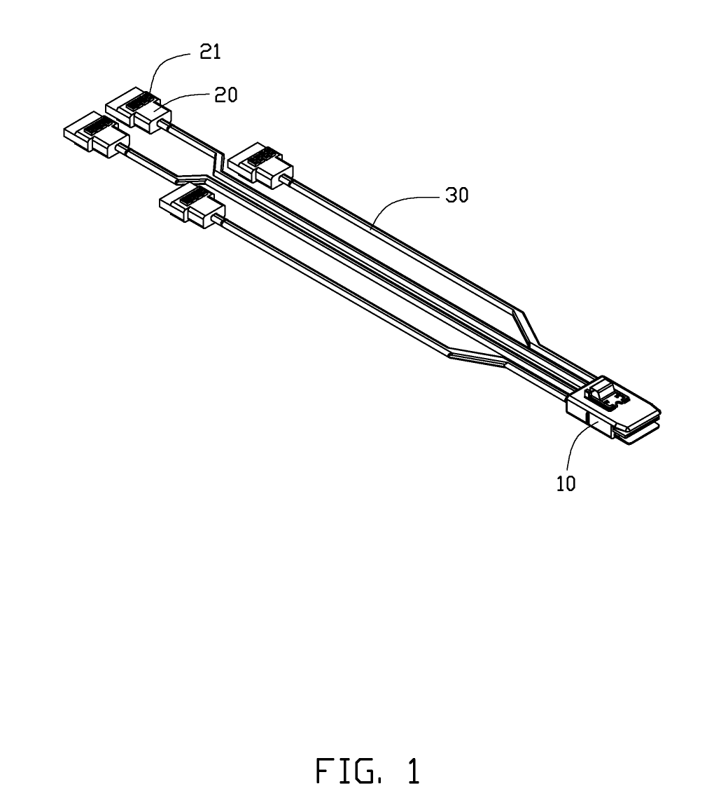

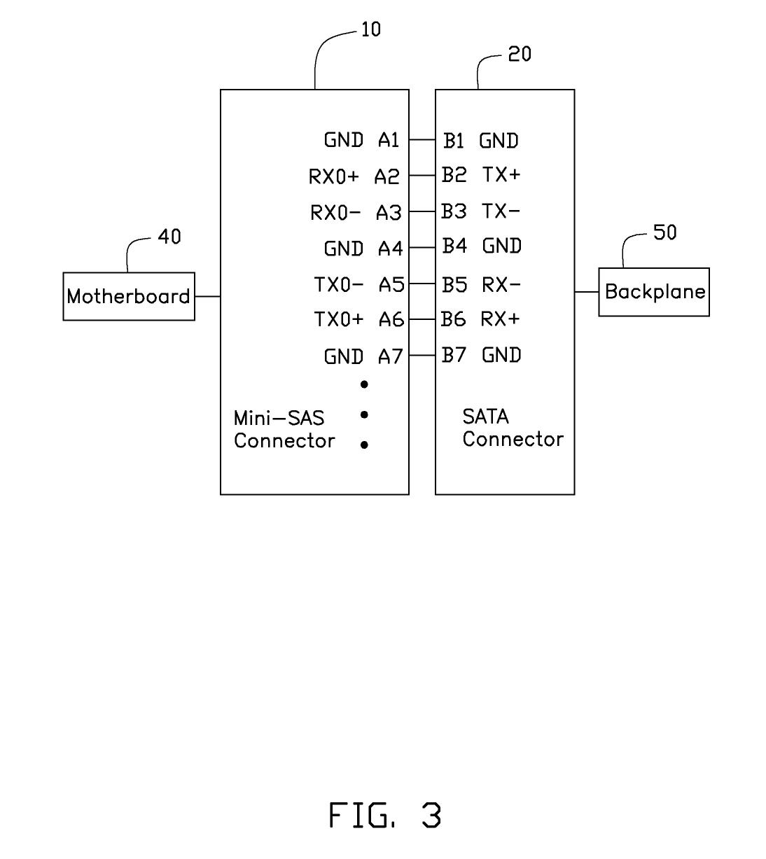

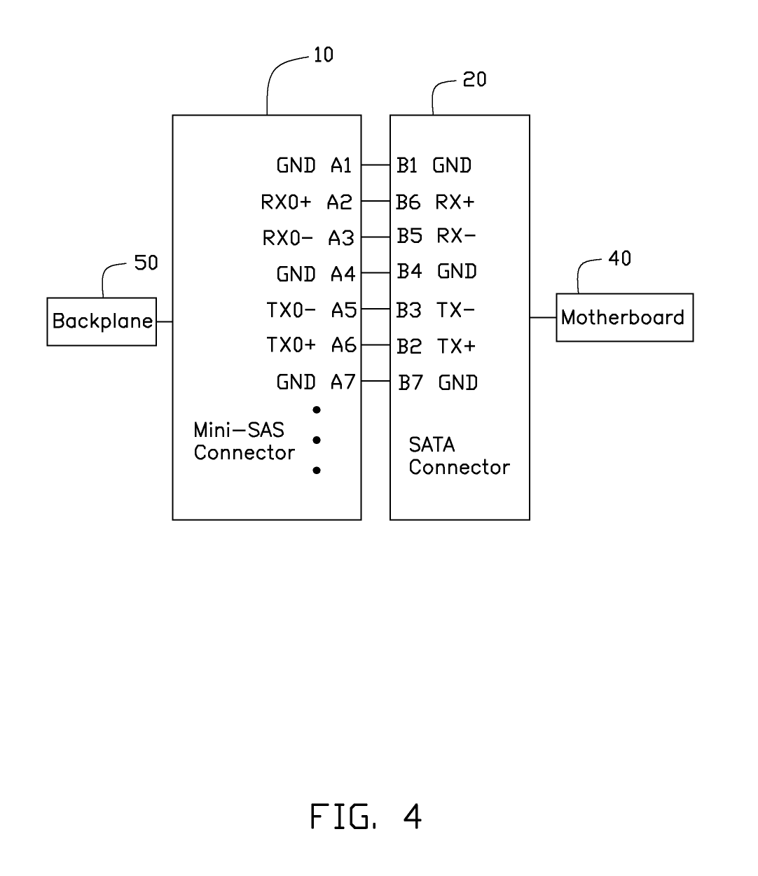

Referring to FIG. 1, an exemplary embodiment of a connector assembly includes a mini serial attached small computer system interface (Mini-SAS) connector 10, four serial advanced technology attachment (SATA) connectors 20, and four switch units 21. The SATA connectors 20 are respectively connected to the Mini-SAS connector 10 through four cables 30. The connector assembly is used to connect a motherboard 40 to a backplane 50 in a server, as shown in FIGS. 3 and 4.

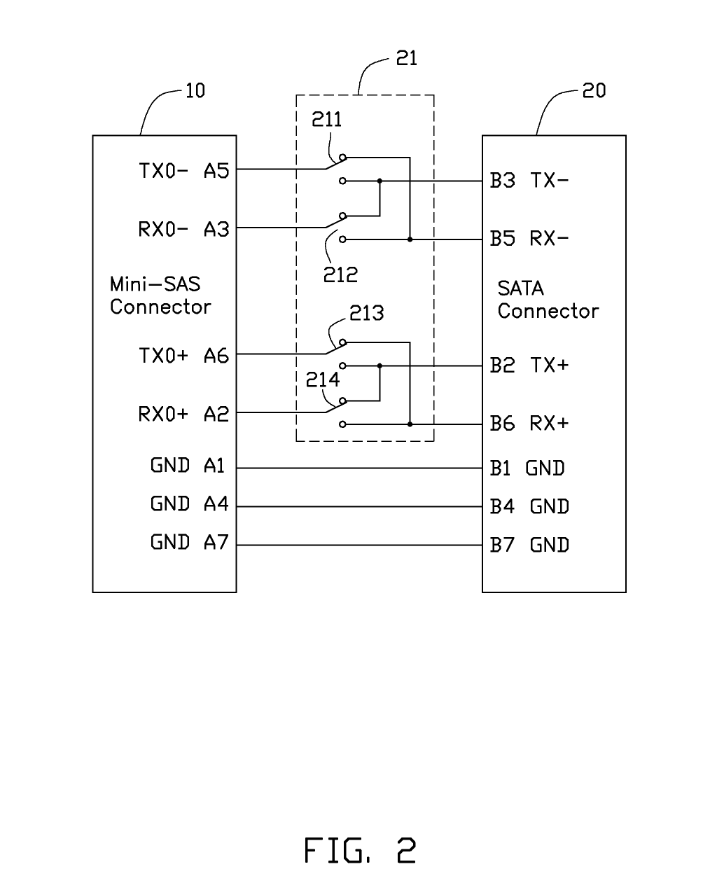

Referring to FIG. 2, the Mini-SAS connector 10 includes four groups of pins (only one group of pins are shown in FIG. 2). Each group of pins are connected to one SATA connector 20. Each group of pins include three ground pins GND (shown as A1, A4, and A7) and four signal pins RX0+, RX0−, TX0−, and TX0+ (shown as A2, A3, A5, and A6). Each SATA connector 20 includes three ground pins GND (shown as B1, B4, and B7) and four signal pins TX+, TX−, RX−, and RX+ (shown as B2, B3, B5, and B6).

Each switch unit 21 is mounted on one corresponding SATA connector 20. In other embodiments, the switch unit 21 can be all mounted on the Mini-SAS connector 10. The switch unit 21 includes first to fourth single-pole double-throw (SPDT) switches 211, 212, 213, and 214. Each SPDT switch includes a pole, a first throw, and a second throw. The pin A5 of the Mini-SAS connector 10 is connected to the pole of the SPDT switch 211. The pin A3 of the Mini-SAS connector 10 is connected to the pole of the SPDT switch 212. The pin A6 of the Mini-SAS connector 10 is connected to the pole of the SPDT switch 213. The pin A2 of the Mini-SAS connector 10 is connected to the pole of the SPDT switch 214. The pin B3 of the SATA connector 20 is connected to the second throw of the first SPDT switch 211 and the first throw of the second SPDT switch 212. The pin B5 of the SATA connector 20 is connected to the first throw of the first SPDT switch 211 and the second throw of the second SPDT switch 212. The pin B2 of the SATA connector 20 is connected to the second throw of the third SPDT switch 213 and the first throw of the fourth SPDT switch 214. The pin B6 of the SATA connector 20 is connected to the first throw of the third SPDT switch 213 and the second throw of the fourth SPDT switch 214. The ground pins A1, A4, and A7 of the Mini-SAS connector 10 are respectively connected to the ground pins B1, B4, and B7 of the SATA connector 20.

Referring to FIG. 3, when the Mini-SAS connector 10 is connected to the motherboard 40, and the SATA connector 20 is connected to the backplane 50, the pole of each SPDT switch is connected to the first throw of the corresponding SPDT switch. At this time, the pin A5 of the Mini-SAS connector 10 is connected to the pin B5 of the SATA connector 20. The pin A3 of the Mini-SAS connector 10 is connected to the pin B3 of the SATA connector 20. The pin A6 of the Mini-SAS connector 10 is connected to the pin B6 of the SATA connector 20. The pin A2 of the Mini-SAS connector 10 is connected to the pin B2 of the SATA connector 20. The ground pins A1, A4, and A7 of the Mini-SAS connector 10 are respectively connected to the ground pins B1, B4, and B7 of the SATA connector 20.

Referring to FIG. 4, when the Mini-SAS connector 10 is connected to the backplane 50, and the SATA connector 20 is connected to the motherboard 40, the pole of each SPDT switch is connected to the second throw of the corresponding SPDT switch. At this time, the pin A5 of the Mini-SAS connector 10 is connected to the pin B3 of the SATA connector 20. The pin A3 of the Mini-SAS connector 10 is connected to the pin B5 of the SATA connector 20. The pin A6 of the Mini-SAS connector 10 is connected to the pin B2 of the SATA connector 20. The pin A2 of the Mini-SAS connector 10 is connected to the pin B6 of the SATA connector 20. The ground pins A1, A4, and A7 of the Mini-SAS connector 10 are respectively connected to the ground pins B1, B4, and B7 of the SATA connector 20. Therefore, the connector assembly can be used when the Mini-SAS connector 10 is connected to the motherboard 40 and the SATA connector 20 is connected to the backplane 50, or when the Mini-SAS connector 10 is connected to the backplane 50 and the SATA connector 20 is connected to the motherboard 40.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A connector assembly connected between a motherboard and a backplane, the connector assembly comprising:
a mini serial attached small computer system interface (Mini-SAS) connector comprising at least one group of pins, wherein each group of pins comprises first to seventh pins, the first pin, the fourth pin, and the seventh pin are ground pins, the second pin, the third pin, the fifth pin, and the sixth pin are signal pins;
at least one serial advanced technology attachment (SATA) connector, wherein each SATA connector comprises first to seventh pins, the first pin, the fourth pin, and the seventh pin are ground pins, the second pin, the third pin, the fifth pin, and the sixth pins are signal pins; and
at least one switch unit, wherein each switch unit comprises first to fourth single-pole double-throw (SPDT) switches, each SPDT switch comprises a pole, a first throw, and a second throw, the fifth pin of the Mini-SAS connector is connected to the pole of the first SPDT switch, the third pin of the Mini-SAS connector is connected to the pole of the second SPDT switch, the sixth pin of the Mini-SAS connector is connected to the pole of the third SPDT switch, the second pin of the Mini-SAS connector is connected to the pole of the fourth SPDT switch, the third pin of the SATA connector is connected to the second throw of the first SPDT switch and the first throw of the second SPDT switch, the fifth pin of the SATA connector is connected to the first throw of the first SPDT switch and the second throw of the second SPDT switch, the second pin of the SATA connector is connected to the second throw of the third SPDT switch and the first throw of the fourth SPDT switch, the sixth pin of the SATA connector is connected to the first throw of the third SPDT switch and the second throw of the fourth SPDT switch, the first pin, the fourth pin, and the seventh pin of the Mini-SAS connector are respectively connected to the first pin, the fourth pin, and the seventh pin of the SAS connector;
wherein when the Min-SAS connector is connected to the motherboard, and the SATA connector is connected to the backplane, the poles of the first to fourth SPDT switches are correspondingly connected to the first throws of the first to fourth SPDT switches; when the Min-SAS connector is connected to the backplane, and the SATA connector is connected to the motherboard, the poles of the first to fourth SPDT switches are correspondingly connected to the second throws of the first to fourth SPDT switches.

2. The connector assembly of claim 1, wherein said at least one SATA connector comprises four SATA connectors and said at least one switch unit comprises four switch units, the Mini-SAS connector comprises four groups of pins correspondingly connected to the pins of the four SATA connectors, each switch unit is mounted on a corresponding SATA connector.
